(19) United States
(12) Patent Application Publication
(10) Pub. No.: US 2022/0196412 A1
(43) Pub. Date: Jun. 23, 2022

(54) METHOD OF NAVIGATING AND NAVIGATION APPARATUS FOR DELIVERY SERVICE

(71) Applicant: NAVISOFT CO., LTD., Daegu (KR)

(72) Inventor: Joo Chul LEE, Seoul (KR)

(21) Appl. No.: 17/455,751

(22) Filed: Nov. 19, 2021

(30) Foreign Application Priority Data
Dec. 18, 2020 (KR) 10-2020-0178207

(51) Int. Cl. G01C 21/34; G01C 21/36; G06Q 10/08

(52) U.S. Cl. CPC G01C 21/3423; G06Q 10/08355; G01C 21/3626

(57) ABSTRACT

A method of navigating for a delivery service and a navigation apparatus thereof are disclosed. When the navigation apparatus receives a delivery list including address information of a delivery object, the navigation apparatus may set a vehicle movement path that includes a plurality of stopping points based on the address information of the delivery object, set a walking movement path starting at the plurality of stopping points based on the address information of the delivery object, and then perform a road guidance according to the vehicle movement path and the walking movement path.

### CROSS-REFERENCE TO RELATED APPLICATION

This application is based on and claims priority under 35 U.S.C. § 119 to Korean Patent Application No. 10-2020-0178207, filed on Dec. 18, 2020, in the Korean Intellectual Property Office, the disclosure of which is incorporated by reference herein in its entirety.

### BACKGROUND

### 1. Technical Field

Embodiments of the present disclosure relate to a method of navigating and apparatus for guiding a path, and more particularly, to a method of navigating and a navigation apparatus for guiding a movement path of a vehicle and a delivery man for a delivery service.

### 2. Description of Related Technology

There is a conventional navigation apparatus that guides a path based on an address. The conventional navigation apparatus provides the shortest distance path or the shortest time path for reaching a destination point after identifying a current position using a global positioning system (GPS), etc. The delivery man may use the conventional navigation apparatus to identify a delivery position of a delivery object and then perform a delivery service. However, it is practically impossible to input the address information of dozens or hundreds of delivery objects to be delivered on the same day into the navigation apparatus one by one because it takes a lot of time. Therefore, most of the delivery man look at the addresses written on all delivery object to be delivered on the same day, based on their geographical knowledge and experience of delivery areas where they are in charge of, and roughly estimate an optimal path for the entire delivery object and then perform the delivery service. However, delivery paths vary according to the knowledge and experience of each delivery man, it takes a lot of time to arrange the delivery object according to a delivery order, making it difficult to perform efficiently the delivery service.

### SUMMARY

The present disclosure provides a method of navigating and a navigation apparatus that enables efficient delivery service by providing an optimal movement path including a walking movement path from a vehicle to a delivery position of a delivery object as well as a vehicle movement path.

Additional aspects will be set forth in part in the description which follows and, in part, will be apparent from the description, or may be learned by practice of the presented embodiments of the disclosure.

According to an aspect of the present disclosure, there is provided a method of navigating for a delivery service, the method including: receiving a delivery list including address information of a delivery object; setting a vehicle movement path including a plurality of stopping points based on the address information of the delivery object; setting a walking movement path starting at the plurality of stopping points based on the address information of the delivery object; and performing a road guidance according to the vehicle movement path and the walking movement path.

According to an aspect of the present disclosure, there is provided a navigation apparatus for a delivery service, including: a list input unit for receiving a delivery list including address information of a delivery object; a first path setting unit for setting a vehicle movement path including a plurality of stopping points based on the address information of the delivery object; a second path setting unit for setting a walking movement path starting at the plurality of stopping points based on the address information of the delivery object; and a path guiding unit for performing a road guidance according to the vehicle movement path and the walking movement path.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a diagram showing an example of a navigation apparatus according to an embodiment of the present disclosure.

FIG. 2 is a flowchart showing an example of a navigation method for a delivery service according to an embodiment of the present disclosure.

FIG. 3 is a diagram showing an example of a vehicle movement path according to an embodiment of the present disclosure.

FIG. 4 is a diagram showing an example of an enlarged screen of a vehicle movement path according to an embodiment of the present disclosure.

FIG. 5 is a diagram showing an example of a method of identifying a plurality of stopping positions for setting a vehicle movement path according to an embodiment of the present disclosure.

FIG. 6 is a diagram showing an example of a method of guiding a walking movement path according to an embodiment of the present disclosure.

FIG. 7 is a diagram showing an example of a method of arranging a delivery list according to a delivery order of delivery objects according to an embodiment of the present disclosure.

FIG. 8 is a diagram showing an example of a screen interface for a navigation for a delivery service according to an embodiment of the present disclosure.

FIG. 9 is a diagram showing a configuration of an example of a navigation apparatus according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a method of navigating for a delivery service according to an embodiment of the present disclosure will be described in detail with reference to the accompanying drawings.

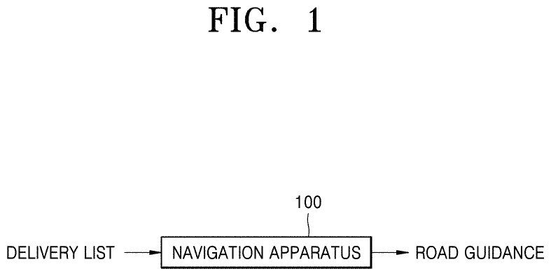

FIG. 1 is a diagram showing an example of a navigation apparatus according to an embodiment of the present disclosure.

Referring to FIG. 1, when a delivery list of delivery objects is input, a navigation apparatus 100 may set and guide a delivery path based on address information included in the delivery list of the delivery objects. The navigation apparatus 100 may be implemented in a smartphone or implemented in a separate dedicated device. The navigation apparatus 100 may include a positioning device, such as a GPS, which may identify a current position thereof.

The delivery list may include delivery object identification information (e.g., delivery object receipt number, etc.) and the address information thereof. For example, the navigation apparatus 100 may be provided with a delivery list in the form of an electronic document such as an excel file. For example, the navigation apparatus 100 may receive the delivery list from an external device via a wired interface such as an universal serial bus (USB) port, or a wireless interface such as Bluetooth or Wi-Fi. Alternatively, the navigation apparatus 100 may receive the delivery list allocated to itself after connecting to a predefined internet site. As another example, the navigation apparatus 100 may generate the delivery list by reading barcodes or quick response (QR) codes of a courier invoice attached to a delivery object, etc. through a camera or a barcode reader, and the like. In addition, the navigation apparatus 100 may receive the delivery list through a variety of conventional methods for receiving the delivery list, for implementing embodiments of the present disclosure.

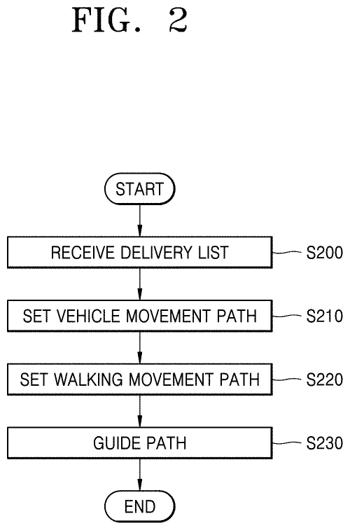

The navigation apparatus 100 may provide a vehicle movement path and a walking movement path. The vehicle movement path may refer to a path through which a vehicle is moving, and the walking movement path may refer to a path through which after stopping the vehicle and unloading the delivery object, a delivery man is moving from an stopping position to a delivery position thereof. When traveling on foot, the delivery man may load and carry several delivery objects on a handcart (or a pulling cart) or a motor cart. In some other embodiments, the walking movement path may refer to a path through which a robot or a drone is moving for the unmanned delivery of delivery objects from a vehicle stopping position to a destination point. A method of identifying a delivery service path including a vehicle movement path and a walking movement path by the navigation apparatus 100 will be specifically described below in FIG. 2.

FIG. 2 is a flowchart showing an example of a method of navigating for a delivery service according to an embodiment of the present disclosure.

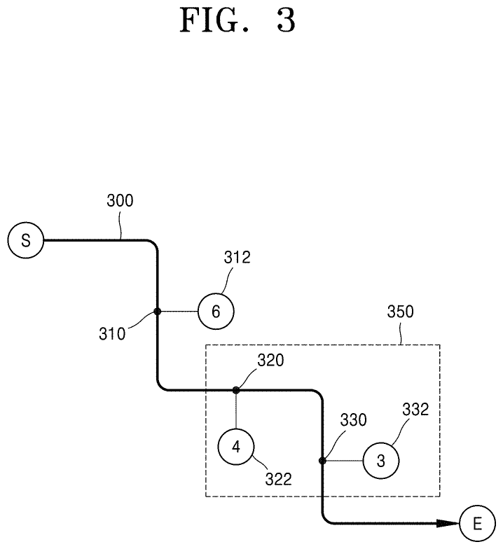

Referring to FIG. 2, the navigation apparatus 100 may receive the delivery list including the address information of the delivery object (S200). The navigation apparatus 100 may set the vehicle movement path that includes a plurality of stopping points based on the address information of the delivery list (S210). Here, the stopping point of the vehicle movement path may refer to a position where the vehicle stops for the delivery of delivery object. The delivery man may stop the vehicle at the stopping point and then deliver the delivery object to a delivery position. An example of the vehicle movement path is shown in FIG. 3.

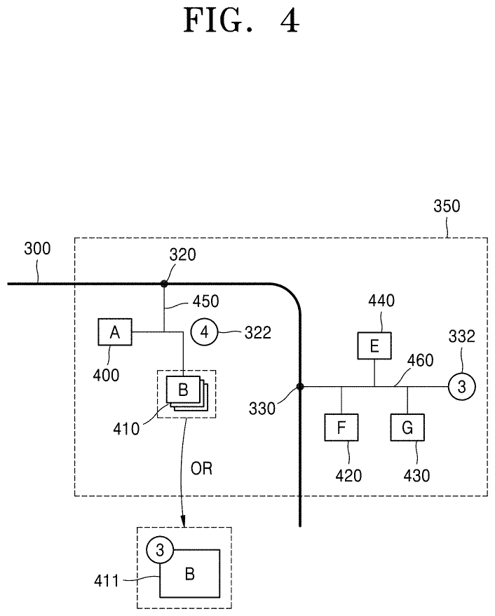

When the vehicle movement path is set, the navigation apparatus 100 may set the walking movement path that is initiated at each stopping point of the vehicle movement path (S220). For example, when the plurality of delivery objects to be delivered to the same apartment complex exist, the stopping point of the vehicle movement path may be a certain position (for example, a ground parking lot, etc.) of the apartment complex, and the walking movement path may be a movement path from the stopping point thereof to the building/housing of the apartment corresponding to the address information of each the delivery objects. As another example, in the case of a general housing area in which a single-family house or a multi-family housing is present, the stopping point of the vehicle movement path may be a certain position in the general housing area (e.g., an entry road in the general housing area or a parking lot in a residential area, etc.), and the walking movement path may be the movement path from the stopping point thereof to each house corresponding to the address information of the delivery object. An example of the walking movement path is shown in FIGS. 4 to 6.

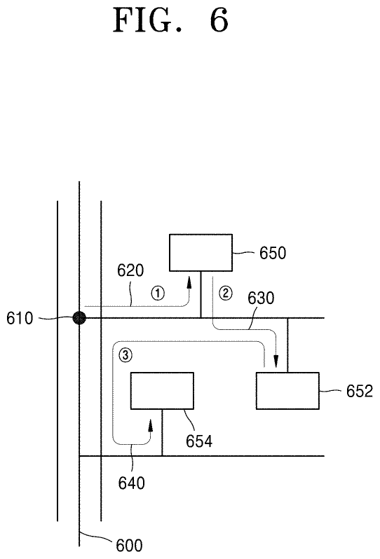

The navigation apparatus 100 may start to guide the path based on settings of the vehicle movement path and the walking movement path (S230). For example, when moving by the vehicle, the navigation apparatus 100 may mainly display the vehicle movement path as shown in FIG. 3 on a map, and when the vehicle approaches or stops at the stopping point, the navigation apparatus 100 may display the walking movement path which is initiated at the corresponding stopping point as shown in FIG. 6.

In another embodiment, when the vehicle stops at the stopping point of the vehicle movement path, the navigation apparatus 100 may display the number of the delivery object to be unloaded and the delivery object list to be unloaded (including the delivery object identification information) at the stopping point to prevent the delivery of the delivery object from being missing.

In another embodiment, the navigation apparatus 100 may guide the walking movement path for each delivery object when there are the plurality of delivery objects to be delivered from the stopping point. For example, when there are three positions to deliver the delivery object as shown in FIG. 6, the navigation apparatus 100 may guide the walking movement path of each delivery object by identifying an optimal distance or the shortest distance.

FIG. 3 is a diagram showing an example of a vehicle movement path according to an embodiment of the present disclosure.

Referring to FIG. 3, the navigation apparatus 100 may set the vehicle movement path 300 including a plurality of stopping points from a starting point S to a destination point E. The starting point S may be a loading position of the delivery object or a current position of the navigation apparatus 100, and the destination point E may be a predefined position, such as a vehicle's garage. The navigation apparatus 100 may set the optimal distance, the shortest distance, or the shortest time distance via a plurality of stopping points 310, 320, and 330, so that the delivery object reaches from the starting point S to the destination point E. In other words, the navigation apparatus 100 may set the vehicle movement path 300 from the starting point S to the destination point E via the plurality of stopping points 310, 320, and 330. Various conventional methods for setting a movement path may be applied to set the movement path via the starting position S and the destination point E, and the plurality of stopping points 310, 320, and 330, which are traveling positions thereof. In another embodiment, the destination point E may not be specified separately. In this case, the destination point E may be the last stopping point 330.

For the convenience of explanation, although the stopping points 310, 320, and 330 are shown to be in branch points in which the vehicle movement path and the walking movement path meet, it is not necessarily the meaning that the vehicle should be stopped at the branch points, and in a practical field, the vehicle may be stopped in a place that is easy to stop, is safe, and does not interfere as much as possible with the passage of other vehicles, around the branch points.

For the convenience of explanation, in the present embodiment, the vehicle movement path 300 is shown in a simplified schematic diagram, but the vehicle movement path 300 may be displayed so as to be superimposed on the map. That is, the navigation apparatus 100 may display the vehicle movement path 300 on the map based on the current position.

In the vehicle movement path 300, the number of delivery objects to be delivered may display in each stopping point 310, 320, and 330. For example, in the case of the present embodiment, the numbers of delivery objects to be delivered from a first stopping point 310, a second stopping point 320, and a third stopping point 330 in the vehicle movement path 300 may be 6 as shown in a position 312, 4 as shown in a position 322, and 3 as shown in a position 332, respectively, as displayed with the vehicle movement path 300. In one embodiment, the navigation apparatus 100 may guide the number of delivery objects to be delivered by voice upon arriving at the stopping points 310, 320, and 330.

In another embodiment, the navigation apparatus 100 may display detailed delivery information of the delivery objects to be delivered from each stopping point 310, 320 and 330 when the vehicle movement path 300 is enlarged and displayed. For example, when the delivery man enlarges a region 350 including the second and third stopping points of the vehicle movement path 300, the navigation apparatus 100 may display positions of the delivery objects, etc. in the corresponding region as shown in FIG. 4.

In another embodiment, when the vehicle is moving, the navigation apparatus 100 may display the vehicle movement path 300 as shown in FIG. 3 on the map, and when the vehicle enters within a predefined distance (e.g., within 100 m, etc.) from the stopping point or stops at the stopping point, the navigation apparatus 100 may automatically expand and display the positions of the delivery objects, etc. in the corresponding stopping point as shown in FIG. 4, which are automatically enlarged.

FIG. 4 is a diagram showing an example of an enlarged screen of a vehicle movement path according to an embodiment of the present disclosure.

Referring to FIG. 4, when the vehicle movement path 300 is enlarged, the navigation apparatus 100 may display detailed information such as delivery positions 400, 410, 420, 430, and 440 and delivery quantity 322 and 332 to be delivered at the stopping points 320 and 330. For the convenience of explanation, the diagram of the present embodiment illustrates only the delivery positions 400, 410, 420, 430, and 440 without the map, but the delivery positions 400, 410, 420, 430, and 440, and the like may be displayed so as to be superimposed on the map.

For example, lines 450 and 460 connecting the stopping points 320 and 330 to the delivery positions 400, 410, 420, 430 and 440 of each delivery object may represent walking paths (e.g., a back road, an alleyway, a movement path within the apartment complex, and the like). Therefore, the lines 450 and 460 connecting the stopping points 320 and 330 to each of the delivery positions 400, 410, 420, 430 and 440 may appear in various ways on the map according to actual road shapes such as a curve rather than a straight line, but the diagram of the present embodiment is shown in a simplified manner to facilitate understanding.

In another embodiment, marks A, B, E, F, and G representing the delivery positions 400, 410, 420, 430, and 440 of the delivery objects may be displayed so as to be superimposed on a building or the like on the map. In the diagram of the present embodiment, the delivery positions 400, 410, 420, 430, and 440 of the delivery objects are shown with the marks A, B, E, F, and G, and the like in square boxes, but this is only one example, the delivery positions 400, 410, 420, 430, and 440 may be displayed in various forms. In addition, various information (e.g., identification information, receipt number, or address information of the delivery object) which may identify the delivery object may be displayed in the delivery positions 400, 410, 420, 430, and 440 of the delivery object. In another embodiment, the navigation apparatus 100 may display the delivery positions 400, 410, 420, 430, and 440 of each delivery object on the map, and when the delivery man clicks each of the delivery positions 400, 410, 420, 430, and 440, the detailed information (receipt number, address, recipient, etc.) of the delivery objects corresponding to the delivery positions may be displayed so as to be superimposed on the delivery position on the map.

In another embodiment, when spatial coordinates of the delivery points are duplicated in communal dwellings such as apartments or multi-family dwellings, the navigation apparatus 100 may display the plurality of delivery positions superimposed, or the navigation apparatus 100 may display only the number of delivery objects on one side of the square box 411 of the delivery positions. In addition, various methods for displaying delivery positions 400, 410, 420, 430, and 440, and the information of delivery objects may be applied to this embodiment, and the displayed information (number, identification information, etc.) of the delivery objects may be guided by voice while moving.

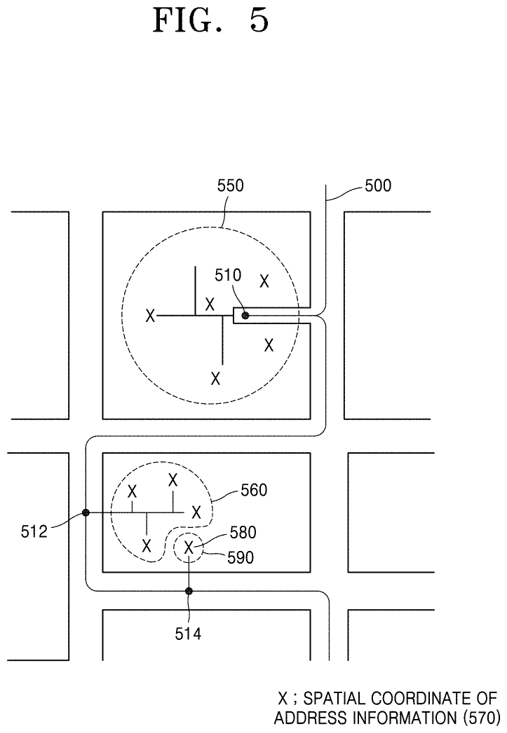

FIG. 5 is a diagram showing an example of a method of identifying a plurality of stopping positions for setting a vehicle movement path according to an embodiment of the present disclosure.

Referring to FIG. 5, the navigation apparatus 100 may group the address information of the delivery objects into a plurality of groups 550 and 560. Grouping of address information may be performed based on the position in an actual space indicated by the address information.

In one embodiment, the navigation apparatus 100 may group a plurality of address information in which the distance of the spatial coordinate 570 indicated by each address information is present within a predefined range, into groups 550 and 560. For example, the address information of the same apartment complex may be grouped into one group. That is, in the case of the communal dwelling such as the apartment complexes, the address information may be grouped into one group based on a lot number, an apartment name, or spatial coordinate of the address.

In the case of a general housing complex, attention may be required when grouping address information adjacent to each other in the spatial coordinates into one group. Even if two addresses are immediately adjacent in the spatial coordinates, the paths to the two addresses may be different due to roads, rivers, building entrance passages, and fences, and the like. For example, as shown in FIG. 5 of this embodiment, there may be a delivery position 580 adjacent to a space of a second group 560, but not directly reachable from a stopping point 512 of the second group 560. In this case, the address information of the delivery position 580 may be grouped to a third group 590 other than the second group 560.

As another example of grouping, after the navigation apparatus 100 groups the address information based on the spatial coordinates into the groups 550 and 560, the navigation apparatus 100 may exclude a delivery position (e.g., the delivery position 580 adjacent to the second group 560) in which the distance of the path that connects between the delivery positions within the group 550 and 560 to each other is greater than the predefined distance, from the corresponding group and may assign it to another group. In addition, the address information may be grouped using a conventional node connection algorithm and the like.

The navigation apparatus 100 may set the vehicle movement path via a representative address of each of the groups 550, 560, and 590 when address grouping is completed. The representative address may be an arbitrarily address selected from among the address information included in each of the groups 550, 560, and 590, an address of a center position of each group, or an address closest to the center position of each group.

Depending on the types of road within each group, the stopping point of the vehicle may be determined. For example, assume that the representative address is the center position of each group or the closest position to the center position of each group. In this case, the navigation apparatus 100 may determine a point at which the vehicle may be closest to the center of first group 550 as the stopping point 510 because the road exists close to the center thereof in the first group 550, and may determine a point adjacent to the second group 560 as the stopping point 512 because there is no road or a narrow back road that is difficult for the vehicle to enter. In other words, the stopping point may be determined to be a point where the distance of the walking movement path in each group becomes the minimum. Then, the navigation apparatus 100 may set the vehicle movement path 500 via the stopping points 510, 512, and 514 of each of the groups 550, 560, and 590.

FIG. 6 is a diagram showing an example of a method of guiding a walking movement path according to an embodiment of the present disclosure.

Referring to FIG. 6, the navigation apparatus 100 may guide the walking movement path 620, 630 and 640 for each of the delivery positions 650, 652, and 654 in the stopping point 610 of the vehicle movement path 600. The navigation apparatus may designate the stopping point as a starting point and a destination point, and generate the walking movement path with at least one delivery position as a stopover, using various conventional path setting methods.

For example, when there are three delivery objects to be delivered in the stopping point 610, the walking movement path may include a first path from the stopping point to a first delivery position, a second path from the first delivery position to a second delivery position, and a third path from the second delivery position to a third delivery position, and thus the navigation apparatus 100 may guide each path in order.

In another embodiment, the navigation apparatus 100 may check whether the delivery man has visited each of the delivery positions 650, 652, and 654 to determine whether delivery of the delivery object is missing. For example, when there is a history of visits to the first delivery position 650 and the second delivery position 652 and there is no history of visits to the third delivery position 654 through real-time positioning of the navigation apparatus 100, the navigation apparatus 100 may notify the delivery man that the delivery of the delivery object to the third delivery position 654 is missing through voice, text, and the like.

In another embodiment, the walking movement path may be an unmanned movement path in which the robot or the drone delivers the delivery objects from the vehicle stopping position to the delivery position. The robot and the drone may be an apparatus that may be moved depending on the autonomous mobile algorithm after mounting at least one delivery object. Various types of robots and drones may be applied to this embodiment for avoiding obstacles to reach the destination point. For example, when the vehicle stops at the stopping point for delivery, the navigation apparatus 100 may transmit the walking movement path for the delivery of delivery objects at the corresponding stopping point to the robot or the drone, through a wired or wireless communication network. In another embodiment, when the robot or the drone receives at least one delivery position information such as the address or the coordinate of the delivery object to be delivered at the corresponding stopping point, the robot or the drone may directly determine the walking movement path passing through at least one delivery position. In another embodiment, the delivery man directly set the walking movement path to the robot or the drone.

In another embodiment, the robot may perform a secondary role to follow a pre-specified delivery man when the delivery man loads the delivery object. In this case, the walking movement path may not be input to the robot. When the delivery man moves along the walking movement path provided by the navigation apparatus 100, the robot may be a programmed apparatus to follow the delivery man.

The walking movement path of the drone may differ from the walking movement path of the delivery man. The drone may fly and reach the delivery position, and therefore, the navigation apparatus 100 may identify and provide a first walking movement path for the delivery man or the robot and a second walking movement path for the drone, or identify and provide both the first and second walking movement path.

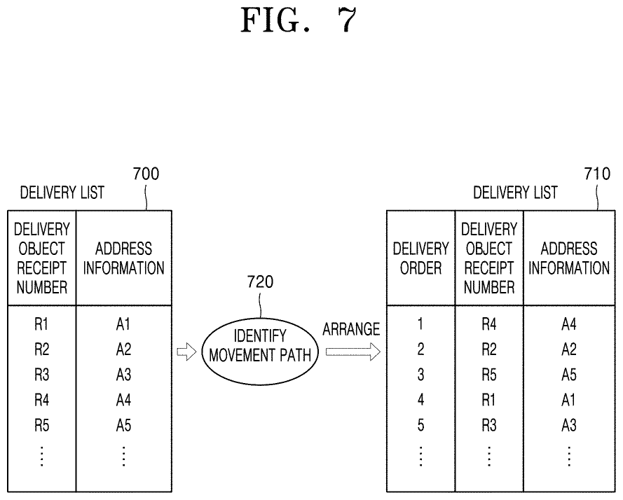

FIG. 7 is a diagram showing an example of a method of arranging a delivery list according to a delivery order of delivery objects according to an embodiment of the present disclosure.

Referring to FIG. 7, the navigation apparatus 100 may set the vehicle movement path and the walking movement path for the delivery of delivery object based on the address information of the delivery objects in a delivery list 700 by the method described above (720). When the vehicle movement path and the walking movement path are set, the delivery order of each of the delivery objects may be determined.

The navigation apparatus 100 may arrange a delivery list 710 according the delivery order when the delivery order of delivery objects according to a delivery path of the delivery objects is determined. The delivery man may load the delivery objects into the vehicle in the order of delivery by using the arranged delivery list 710. In general, the delivery object to be delivered last in the delivery order may be loaded into the vehicle first, and the delivery object to be delivered first may be loaded into the vehicle last.

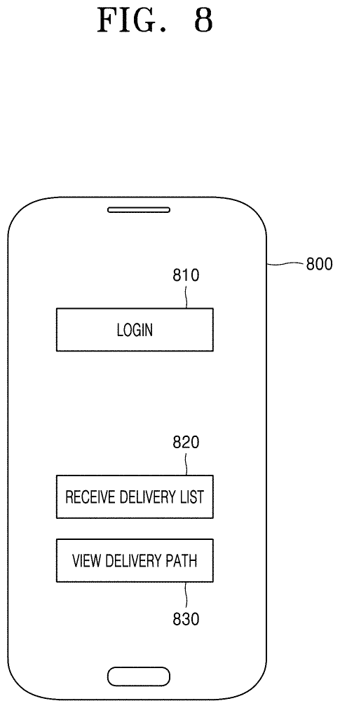

FIG. 8 is a diagram showing an example of a screen interface for a navigation for a delivery service according to an embodiment of the present disclosure.

Referring to FIG. 8, when a method for the navigation of delivery service is implemented as an application of a smartphone 800 and when the delivery man drives a delivery service navigation application installed on the smartphone 800, the screen interface for the delivery service navigation may be displayed on a screen. After logging in ‘login’ 810, the delivery man click ‘receive delivery list’ 820 for receiving the delivery list and select ‘view delivery path’ 830 for receiving delivery path guidance.

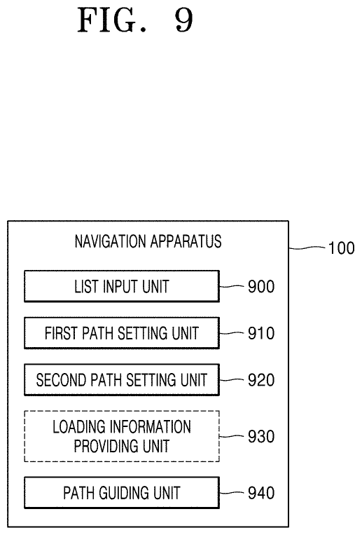

FIG. 9 is a diagram showing a configuration of an example of a navigation apparatus according to an embodiment of the present disclosure.

Referring to FIG. 9, the navigation apparatus 100 may include a list input unit 900, a first path setting unit (or a first path setting processor) 910, a second path setting unit (or a second path setting processor) 920, a loading information providing unit (or a loading information providing processor) 930, and a path guiding unit (a path guiding processor) 940. In some embodiments, the loading information providing unit 930 may be omitted.

The list input unit 900 may receive the delivery list that includes address information of the delivery object.

The first path setting unit 910 may set the vehicle movement path including at least one stopping point for delivery of the delivery object. An example of a method of setting the vehicle movement path is shown in FIGS. 3 to 5.

The second path setting unit 920 may set the walking movement path starting at the stopping point of the vehicle movement path. An example of the walking movement path is shown in FIG. 6.

The loading information providing unit 930 may arrange and provide the delivery list to match the delivery order. An example of arranging the delivery list to match the delivery order is shown in FIG. 7.

The path guiding unit 940 may guide the path according to the vehicle movement path and the walking movement path. The path guiding unit 940 may display and guide the vehicle movement path on the map while the vehicle is moving, and display and guide the walking movement path on the map when the vehicle stops at the stopping point. In addition, it may be also possible to provide a service for guiding the delivery object information (number, identification information, etc.) displayed on the screen through voice output while moving. For example, it may be output by voice, such as “There are two delivery objects on the left. The number of delivery objects are 1 and 3”.

The present disclosure may also be implemented as a computer-readable code to a computer-readable recording medium. The computer-readable recording medium may include all kinds of recording devices where data that may be read by a computer system are stored. Examples of the computer-readable recording medium may include ROM, RAM, CD-ROM, magnetic tapes, floppy disks, and optical data storage devices. In addition, the computer-readable recording medium may also be dispersed in a computer system connected to a network to store and execute code where a computer-readable code may be stored in a distribution manner.

According to an embodiment of the present disclosure, the vehicle movement path and the walking movement path may be provided together to enable efficient delivery service. When delivering the delivery objects to residential areas, etc., it is often difficult for vehicles to enter the back roads or narrow alleys. In addition, since positions of a large amount of delivery objects to be delivered may be concentrated in downtown areas, there may be many cases of moving on foot after stopping the vehicle and loading several delivery objects on a handcart or an electric cart. Accordingly, it may be possible to provide the walking movement path together with the delivery navigation to help the delivery service. Even if the electric cart is directly driven, it is considered to correspond to the walk movement of the present disclosure. In another embodiment, the delivery object delivery list may be arranged and provided so that loading and unloading of the delivery objects is possible according to the delivery order of the delivery objects. In another embodiment, it may be possible to prevent the delivery of the delivery object from being missed by presenting the quantity of the delivery objects to be delivered at each stopping point, identification information of the delivery objects, and the like.

In addition, embodiments of the present disclosure may be usefully used not only for the delivery man but also for personnel who work for sorting. For example, when the delivery objects assigned to several delivery man are mixed and combined in one place before loading the delivery objects, the personnel who work for sorting may sort the delivery objects by each delivery area of each delivery man referring to the sorted delivery list of the embodiment of the present disclosure, and at the same time, may arrange the delivery objects in front of a luggage compartment of the vehicle according to the delivery order. In Korean, in order to prevent overworked deaths of the delivery man, one of the reasons for the difficulties in promoting the separation/dualization of classification and delivery by Korean government and the National Assembly is that when sorting, it is necessary to rearrange the delivery objects according to the delivery order and at this time, the reality is that it is difficult to completely exclude the delivery man from the classification work because the person who knows the most about the geographic information of the delivery area is the delivery man. Therefore, it is possible to exclude the delivery man at the time of classification work.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of navigating to be performed by a navigation apparatus for a delivery service, the method comprising:
receiving a delivery list comprising address information of a delivery object;
setting a vehicle movement path comprising a plurality of stopping points based on the address information of the delivery object;
setting a walking movement path starting at the plurality of stopping points based on the address information of the delivery object; and
when the vehicle movement path and the walking movement path are set, performing a road guidance according to the vehicle movement path and the walking movement path,
wherein the setting the walking movement path comprises setting each of the stopping points as a starting point and a destination point and setting a plurality of delivery positions as a stopover, and
wherein the method further comprises determining whether each of the delivery positions has been visited through a real-time position of the navigation apparatus, and notifying delivery missing of the delivery object by voice or text when the delivery of the delivery object is missing.

2. The method of navigating of claim 1, wherein:
the setting the vehicle movement path comprises grouping the address information of the delivery objects into a plurality of groups; and
setting the vehicle movement path to go through a representative address of each group.

3. The method of navigating of claim 2, wherein the representative address is arbitrarily selected from among the address information included in the group, or is the address information in a center position of the group or in closest position to the center position of the group.

4. The method of navigating of claim 1, wherein the performing the road guidance comprises displaying the vehicle movement path and the walking movement path on a map together with a current position of a vehicle.

5. The method of navigating of claim 1, wherein the performing the road guidance comprises displaying the number, identification information, and the delivery positions of the delivery objects to be unloaded at the stopping point in a graphic form together with the walking movement path, when a vehicle for the delivery service reaches close to the stopping point.

6. The method of navigating of claim 1, wherein the performing the road guidance comprises outputting the number and identification information of the delivery objects to be unloaded at the stopping point by voice, when a vehicle for the delivery service reaches close to the stopping point.

7. The method of navigating of claim 1, further comprising arranging the delivery list in a visit order according to the vehicle movement path and the walking movement path and displaying the delivery list in the form of a text list view, for loading the delivery object.

8. A navigation apparatus for a delivery service, comprising:
a list input unit configured to receive a delivery list comprising address information of a delivery object;
a first path setting unit configured to set a vehicle movement path comprising a plurality of stopping points based on the address information of the delivery object;
a second path setting unit configured to set a walking movement path starting at the plurality of stopping points based on the address information of the delivery object; and
a path guiding unit configured to perform a road guidance according to the vehicle movement path and the walking movement path, when the vehicle movement path and the walking movement path are set,
wherein the second path setting unit is configured to set each stopping point as a starting point and a destination point and set a plurality of delivery positions as a stopover, and
wherein the navigation apparatus is configured to determine whether each of the delivery positions has been visited through a real-time position of the navigation apparatus and notify delivery missing of the delivery object by voice or text when the delivery of the delivery object is missing.

9. The navigation apparatus of claim 8, further comprising a loading information providing unit configured to arrange and display the delivery list in a visit order according to the vehicle movement path and the walking movement path.

10. A non-transitory computer-readable recording medium comprising a program for performing the method of claim 1.
